(19) United States
(12) Patent Application Publication
(10) Pub. No.: US 2009/0040102 A1
(43) Pub. Date: Feb. 12, 2009

(54) LOCATION METHOD AND SYSTEM AND LOCATABLE PORTABLE DEVICE

(75) Inventors: Miquel Angel Medina Herrero, Madrid (ES); Alejandra Diaz Diaz, Madrid (ES)

Correspondence Address: CANTOR COLBURN, LLP, 20 Church Street, 22nd Floor, Hartford, CT, 06103, US

(73) Assignee: NAVENTO TECHNOLOGIES, S.L., Madrid (ES)

(21) Appl. No.: 12/112,445

(22) Filed: Apr. 30, 2008

(30) Foreign Application Priority Data
Apr. 30, 2007 (ES) 200701166
Mar. 14, 2008 (ES) 200800757

(51) Int. Cl. G01S 5/14

(52) U.S. Cl. 342/357.07; 342/357.09; 342/357.1

(57) ABSTRACT

Location method for locating a portable device (1) from a server (2) configured to communicate with said portable device (1) through a wireless communication network (3), with the steps of: sending GPS assistance information from the server (2) to the portable device (1) through said wireless communication network (3); obtaining in an A-GPS positioning module (11) a GPS signal (4) from a satellite system (8); calculating a location of the device (1) itself from said GPS signal (4) and from GPS assistance information; and sending said location to the server (2). The method further comprises: when the portable device (1) is stopped, hibernating the A-GPS positioning module (11), the transmission/receiving module (12) and a microprocessor (15) managing said modules (11, 12), such that the battery is saved and the autonomy of the portable device (1) is thus increased; and when the portable device (1) is connected by means of an external cable (19) to a vehicle, said portable device (1) and said external cable (19) form a locator device for the automotive environment (10), which is useful as an anti-theft system which is undetectable due to being radio-electrically transparent.

### FIELD OF THE INVENTION

The present invention relates to the field of location methods and systems including vehicle assisted GPS location methods and systems.

### BACKGROUND OF THE INVENTION

The conventional GPS system is made up of a network of satellites in non-geostationary orbit, a network for controlling and maintaining the network of satellites and a series of receivers that can calculate their approximate position on the surface of the Earth.

The conventional GPS system has certain limitations mainly because of the low power emitted by the satellites and the low sent information transmission rate. These characteristics mean that the Time to First Fix (TTFF) is high (several minutes). The receiving capacity is furthermore generally limited to areas with directive visibility of the satellites.

International patent application WO2006/000605 describes a device for the analysis of the activity of a person and for the automatic detection of falls. The person's position is detected by means of a conventional GPS system and, continuously measures the acceleration of the (by means of an accelerometer) for the purpose of monitoring if the person falls to the ground, such that the fall is associated with a certain instantaneous acceleration value. This device is designed for fall detection, but its efficiency is low as an absolute position detector, especially in interior spaces, where GPS signals easily lose coverage.

The conventional GPS model has been improved by the use of A-GPS (Assisted GPS) technology, which has a direct effect on the TTFF and on receiver sensitivity, broadening reception to areas without direct visibility. In addition to communication with GPS satellites, A-GPS technology is based on the use of certain additional information or assistance which is received by other external means or elements (such as a system server) which aids in locating the receiver.

This assistance can comprise approximate device position information, information on the position of the satellites and/or clock information. According to the manufacturer and the system, the assistance information is formed by the three types of information mentioned or by just one of them.

With the assistance information, which has a time validity and is therefore periodically downloaded from the server to the receiver device, the following improvements occur: the TTFF (GPS signal acquisition times) is reduced, since the receiver is more quickly synchronized with the signal of the satellites and does not require decoding said signal, as it knows a priori the information it is going to receive from them. The time required for location is therefore reduced; the location sensitivity and precision is increased, allowing to fix the position in complicated environments, such as large urban and interior environments; battery consumption is reduced, increasing the autonomy of the system.

On the other hand, one of the main problems in portable location devices is the little autonomy they have, i.e. the reduced number of hours of use they allow without needing to charge the battery. The difficulties in the attempts to improve the maximum charge of the batteries of these devices have led designers of such devices to optimize the consumption control systems of these devices, allowing the main modules to hibernate if they are not used for a certain time period. Therefore, for example, in location devices using mobile telephony (GSM/GPRS) to transmit their position, consumption of the of GSM/GPRS module is reduced to a minimum in the event that the device is connected only to the mobile telephony operator and is not carrying out any information transaction.

Japanese patent application JP11083529 describes a device which can be located as a result of the combination of a GPS receiver, an accelerometer and a gyroscope. Thanks to this combination, the system tries to minimize battery consumption. However, location of the device is always carried out locally in the device itself, without making use of an external element such as a server, slowing down the calculation and jeopardizing location efficiency.

Japanese patent application JP10221427 also describes a device which can be located by means of a GPS positioning system, in which a transmission module is turned off when GPS coverage is lost. The battery is thus saved. However, as in the previous case, location of the device is also achieved locally, thereby not optimizing the calculation and jeopardizing the efficiency of the location.

Although there are systems making use of the aforementioned A-GPS location technology, the normal operation of these systems consists of having the A-GPS module turned off until a location request is received. Unfortunately switching said A-GPS module from off to on affects the autonomy of the device, since the consumption of energy derived from turning on and completely activating an A-GPS module, with the signaling and information exchange involved, is very high.

### SUMMARY OF THE INVENTION

The present invention solves the aforementioned problems by means of a method which, thanks to the combination of the use of sensors present in the portable device and of the use of A-GPS location technology, allows reducing the battery consumption of a GPS location system. In other words, the autonomy of the device increases and the quality of the system is improved since the location time of the device and the battery consumption is reduced and precision of the obtained location is increased.

In one aspect of the present invention, a location method of a portable device from a server configured to communicate with said portable device through a wireless communication network is provided. The method comprises the steps of: sending from the server to the portable device GPS assistance information through said wireless communication network; obtaining in an A-GPS positioning module of the portable device a GPS signal coming from a satellite system; calculating in said portable device a location of the device itself from said GPS signal and from the GPS assistance information sent by the server; sending said location to the server. The method further comprises the steps of: when the portable device is stopped, hibernating the A-GPS positioning module, the transmission/receiving module and a microprocessor of said portable device managing said modules, such that the battery is saved and the autonomy of the portable device is thus increased; and when the portable device is connected by means of an external cable to a vehicle, said portable device and said external cable form a locator device for the automotive environment which is supplied from a battery of said vehicle.

In another aspect of the present invention, a portable device is provided comprising: A-GPS global positioning means configured to receive a GPS signal from a network of GPS satellites; transmission/receiving means configured to be connected to a wireless communication network and to receive therethrough, from a server, at least GPS assistance information and location requests; in which said portable device can calculate its position from said GPS assistance information and from said GPS signal and to send said position to said server. The portable device further comprises motion sensor means which can capture information that can be used for hibernating or interrupting the hibernation of said A-GPS positioning and transmission/receiving modules, according to the absence or presence of motion of the portable device.

In another aspect of the present invention, a device is provided for an automotive environment comprising a portable device such as that described above and an external cable configured to be connected to the vehicle carrying said device for an automotive environment.

In another aspect of the present invention, a location system for locating a portable device is provided comprising: at least one portable device such as that described above; and a server configured to communicate through a data channel with said portable device through a wireless communication network and to automatically provide GPS assistance information to said portable device.

In another aspect of the present invention, a location system is provided comprising: at least a device for an automotive environment such as that described above; and a server configured to communicate through a data channel with said device for an automotive environment through a wireless communication network and to automatically provide GPS assistance information to said device.

Finally, the invention provides a computer program comprising computer program code means adapted to carry out the steps of the previously described method when the mentioned program is executed in a computer, a digital signal processor, an application-specific integrated circuit, a microprocessor, a microcontroller or any other form of programmable hardware.

The invention further provides other embodiments as they are described in the dependent claims.

The method and system of the present invention therefore allow, under certain conditions, sending the location from the server to a user even when the vehicle carrying the device is at rest (low energy consumption mode), it not being necessary to set up communication therewith at that time.

Thanks to the fact the device of the present invention is equipped with the latest technologies based on satellite-assisted location (A-GPS) and mobile communications, high precision can be reached in each of the A-GPS locations carried out.

The service quality of this GPS location system is measured through the response time of the location, of the precision of the location obtained and of the battery consumption of the device.

In other words, and in short, a system is obtained having a service quality that is greater than a conventional GPS system. The high autonomy of the device furthermore does not jeopardize the efficiency thereof or the high service quality achieved, represented by the quick response to the position requests made by a user and by the high probability of a reliable response. This system can even provide the real position of the device to the user, without needing to communicate with the device, the device further being in a low energy consumption mode.

The possibility of configuring and making use of a series of alerts enhancing the functionalities defined in the method is further added.

Finally, the possibility of making use of the device in the automotive environment as an anti-theft system, making use of the battery of the vehicle is offered.

### BRIEF DESCRIPTION OF THE DRAWINGS

For the purpose of aiding in better understanding the features of the invention according to a preferred practical embodiment thereof and to complement this description, a set of illustrative and non-limiting drawings is attached as an integral part thereof. In these drawings:

FIG. 1 shows a diagram of the location system according to an embodiment of the present invention.

FIG. 2a shows a diagram of a portable device which can be located by means of the method and system of the present invention.

FIG. 2b shows a diagram of a locator device adapted for the automotive environment thanks to the use of a cable adaptor according to a preferred embodiment of the present invention.

FIG. 2c shows a diagram of a locator device of a device for an automotive environment according to a preferred embodiment of the present invention.

FIG. 3 shows a diagram of a server of the location system of the present invention.

FIG. 4 shows the state diagram of the operating algorithm of the method and system of the present invention.

FIG. 5 shows the flow chart of the operating algorithm of the method and system of the present invention.

FIG. 6 shows a diagram of the location system according to a preferred embodiment of the present invention.

FIG. 7 shows an example of placing the antennas of the device for an automotive environment in a vehicle.

### DETAILED DESCRIPTION OF THE INVENTION

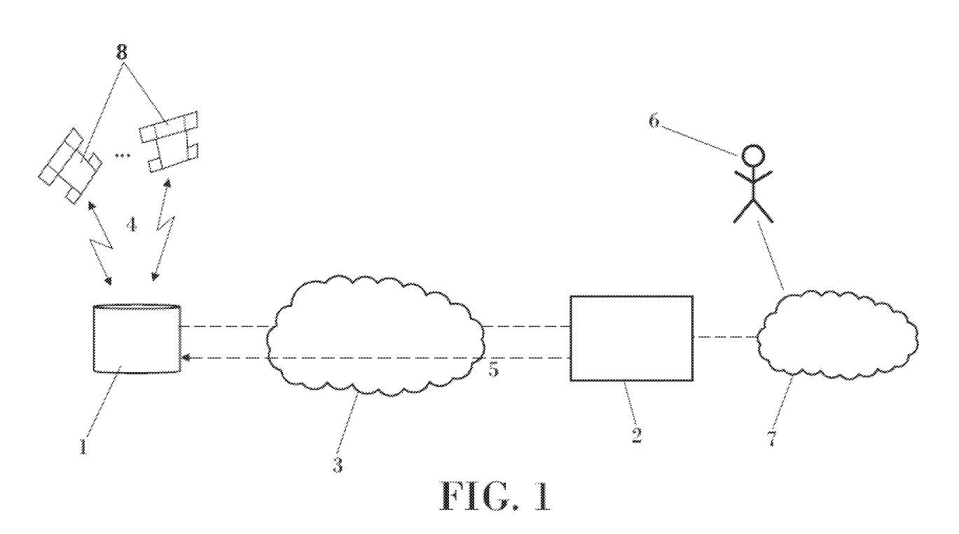

FIG. 1 shows a diagram of the location system. The system comprises a server 2 and one or several portable devices 1 which can be located. FIG. 1 shows a single portable device 1. Communication between the server 2 and the portable device 1 is set up through a wireless communication network 3. Non-limiting examples of possible wireless communication networks are GSM, GPRS, CDMA, PHS, EDGE, UMTS, FOMA, CDMA2000, TD-SCDMA, HSDPA, HSUPA, WiFi, WiMAX and Bluetooth. This wireless communication network 3 is preferably a GSM/GPRS network.

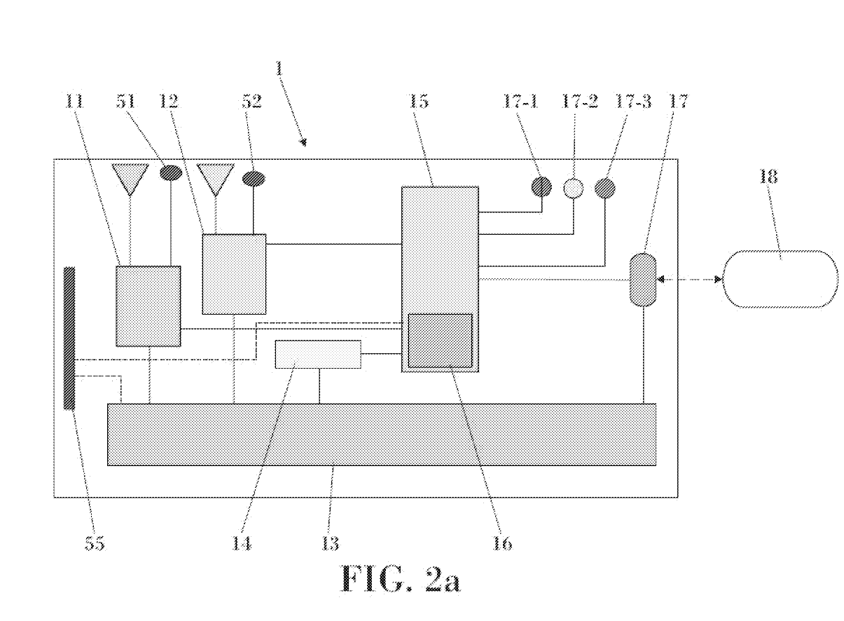

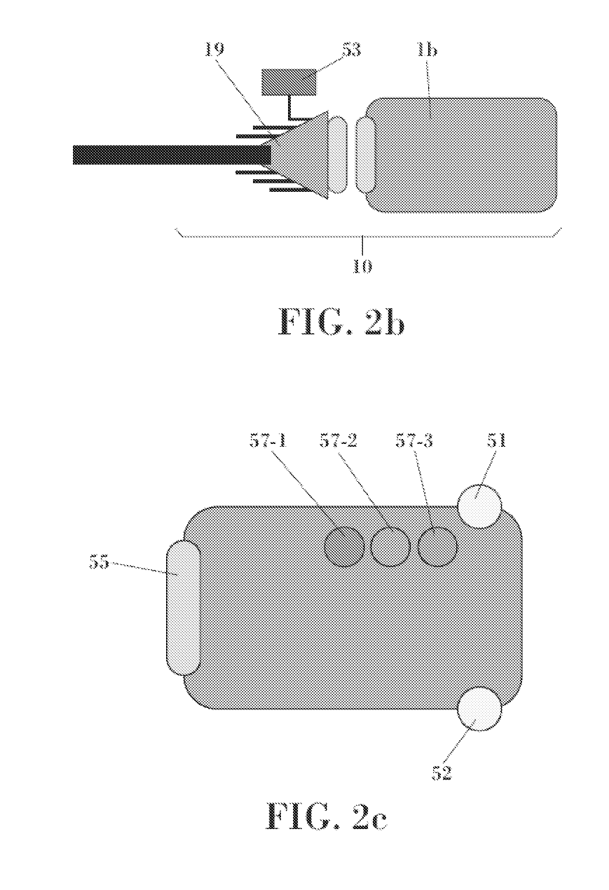

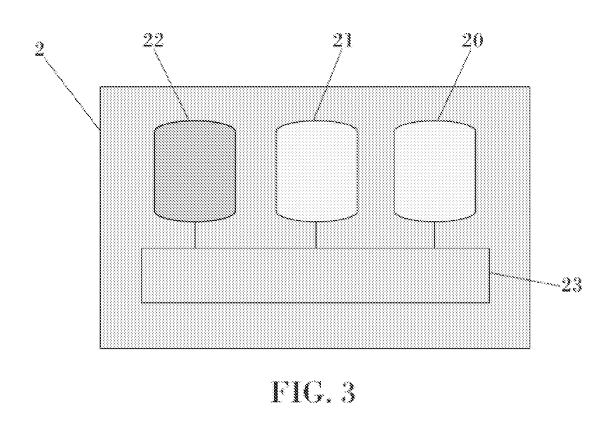

FIG. 2a shows a diagram of the portable device 1. The device 1 is wireless. The device 1 comprises an A-GPS positioning module 11 comprising a GPS receiver. Through this A-GPS positioning module 11, the device 1 can receive GPS signals 4 from a system of satellites 8, GPS assistance information (A-GPS) from a server 2 and can continuously calculate its location provided that it has GPS coverage. Both the GPS signals 4 and the system of GPS satellites 8 are schematically shown in FIG. 1.

The portable device 1 also comprises a transmission/receiving module 12 through which the device 1 communicates with the server 2. This module 12 comprises the conventional elements for setting up wireless communication on a mobile network, such as mobile communication modem, a transmitter/receiver and a SIM card.

The device 1 further comprises a motion sensor 14, which can measure at least the acceleration of the device 1 and thus determine if the device is in motion or at rest (stopped). The motion sensor can also measure at least the gravity value, which is useful for knowing the degree of inclination of the device 1 on the 0° horizontal. The motion sensor 14 is preferably an accelerometer.

The motion sensor 14, preferably an accelerometer, allows, together with other aspects indicated below, switching the A-GPS positioning module 11 and the transmission/receiving module 12 from a microcontroller 15 in a low consumption or hibernated mode, with the subsequent prolongation of the life of the battery 13 or increase in the autonomy of the device 1. In this transition, the microprocessor 16 will also operate in a low energy consumption mode.

In the context of the present invention, “hibernating” is understood as the action of switching a device or device module to a low operating activity and minimum energy consumption state.

In this sense, in the context of the present invention “hibernating an A-GPS positioning module” is understood as the action of switching said module to a state in which the following actions are not carried out: listening and processing GPS signals from satellites, calculating positions and calculating the speed of the device comprising this module. Energy consumption is thus minimized.

Also in the context of the present invention, “hibernating a transmission/receiving module” is understood as the action of switching said module to a state in which the following actions are not carried out: transmitting or receiving information to/from the server, i.e. a communication channel with the server is not set up and therefore there is no transmission/receiving of information between server and device. Energy consumption is thus minimized.

Likewise, in the context of the present invention “hibernating a microprocessor of a device” is understood as the action of switching said microprocessor to a state in which the only activity which is carried out is waiting to see whether there is a signal from a motion sensor, in which case the microprocessor sends an on order to the A-GPS positioning module and transmission/receiving module. Energy consumption is thus minimized.

It must be clarified that switching a device from hibernation to on has an energy consumption that is much lower than switching from turned off to turned on, which has a high energy consumption peak.

In the context of the present invention, “turning on” is understood as the action of switching a device or device module to a normal activity or full efficiency state, with the subsequent energy consumption. This term “turning on” is applied both to a device and to the A-GPS positioning module, transmission/receiving module, motion sensor and microprocessor comprised in said device.

Finally, in the context of the present invention, “turning off” is understood as the action of switching a device or device module to a nil activity state and therefore a state with no energy consumption. This term “turning off” is applied both to a device and to the A-GPS positioning module, transmission/receiving module, motion sensor and microprocessor comprised in said device.

As has already been mentioned, the device 1 also comprises a microprocessor 15, which in turn comprises an information storage means or memory 16. This memory 16 is useful for storing the GPS assistance information (A-GPS) sent from the server 2 to the device 1, local locations carried out by the device 1 and which are not sent by the server 2 due to several circumstances, such as not having coverage of the wireless communication network 3 or because it is designed for this local storage.

The microprocessor 15 and the A-GPS positioning modules 11 and transmission/receiving modules 12 can be in three possible states: off state, involving no energy consumption, on state, involving a normal energy consumption, or low consumption or hibernated state, involving an energy consumption that is lower than the previous state and therefore prolongs the life of the battery of the device 1. In the low consumption or hibernated state, the A-GPS positioning module 11 does not process the GPS signal 4 from the satellites 8 or calculate the positions or the speed of the device 1.

The device 1 also has a power supply battery 13, to supply the modules or elements thereof requiring it. The system prolongs the life of said battery 13 to increase the autonomy of the device 1 with respect to other devices using conventional or autonomous GPS technology.

The device 1 preferably also comprises an access interface 17. This access interface 17 is preferably a USB port. This access interface 17 can be used as an access to several elements, such as the power supply connector of the battery 13 or an encoded key 18 to turn off the device 1 safely and without risk of the manipulation or turning off by persons who are not authorized to turn it off. This is achieved by means of the univocal association between the device 1 and an encoded key 18 which is only valid for a USB belonging to the carrier of the device. This key 18 is shown in FIG. 2a. For example, the encoded key can be useful for turning off the device 1 when its carrier is on a plane. In the event of the loss of the encoded key 18, the device 1 can be turned off by the owner thereof connecting with and identifying himself or herself to the server 2 through a WEB service, or a mobile telephony application, or through a telephone call for example. The USB security key can preferably also be encrypted, in order to prevent an unauthorized person from making a fraudulent copy.

The device 1 preferably also comprises visual indicators 17-1 17-2 17-3 providing the carrier of the device 1 with information on the state of several elements. For example, they can inform about the state of the battery 13, about whether the A-GPS positioning module 11 has coverage and about whether the transmission/receiving module 12 has coverage. These visual indicators are preferably LED diodes.

In a particular embodiment, the LED diodes 17-1 17-2 17-3 have the following functions: If a green light is blinking in a first LED 17-1, it means that the device 1 is turned on. If the green light is steady, it means that the battery 13 is charged and that the device 1 has a power supply from the battery 13 connected to the access interface 17. If a red light is blinking in said LED 17-1, it means that the battery 13 is low. If the red light is steady, it means that the battery 13 is being charged by means of a supply source. If an orange light is blinking in a second LED 17-2, it means that the device 1 has coverage of the mobile communication network 3. If a blue light is blinking in a third LED 17-3, it means that the device 1 has coverage of the system of GPS satellites 8.

The locator device 1 further comprises firmware included in its microprocessor 15, which can be remotely updated via OTA (Over The Air).

The device 1 has a port 55 as an input for an external connecting cable 19 (not shown in FIG. 1), such that its use is allowed in the automotive environment. Due to this possibility, the device 1 can also have two connectors for external GPS antennas 51 and/or of the communication network 52, if necessary.

The system further allows defining area alerts (geofencing) created by the user 6 through the server 2 and loaded in the actual portable device 1. The device 1, being capable of constantly known its position thanks to the A-GPS positioning module 11 and after detecting a defined event associated to the defined area (entrance/exit), triggers the alert which it has defined/associated thereto according to the event: changing the operating mode (tracking under request), sending a short message to a person defined by the user 6, informing the server or other possible actions.

The system further allows defining low battery alerts. In this case the user can select that when the device goes below the battery threshold which he or she has chosen, the user is informed.

The system further allows defining speed alerts. In this case the user can select that when the device exceeds a maximum speed threshold which he or she has chosen, the user is informed.

The system further allows defining motion alerts. In this case the user can select that when the device detects motion, through its motion sensor 14, the user is informed. In the event that the device is being used in the automotive environment, it is more correct to call this alert an anti-theft alert, and it is useful for recovering vehicles in the event that they have been stolen. It must be noted that this anti-theft system remains electrically undetectable by possible thieves, since with the device stopped and with its modules 11 and 12 turned off (in a hibernation state) it is not possible to detect the device for the automotive environment.

The system further allows defining power supply cutoff or failure alerts. This alert can only be applied in the device for the automotive environment. In this case, the user can select that when the device for the automotive environment 10 stops being supplied from the battery of the vehicle through the external connecting cable 19, the user is informed. At this time the device for the automotive environment 10, which is seen in detail in FIG. 2b, then makes use of the internal battery 13, which provides an improvement with respect to the rest of the existing anti-theft systems

The system further allows defining vehicle trailer warning alerts. This alert can only be applied in the device for the automotive environment. In this case, the user can select that when the device detects, through its motion sensor 14, a change in the inclination of the vehicle greater than an amount chosen by the user, the user is informed.

In all possible alert cases, in the event that they occur, the system allows informing the user of the event in different ways, such as by means of a text message to his or her mobile telephone, by means of an e-mail to his or her e-mail address or by means of a phone call.

The system can make use of an element added to the server 2, which is a node called Alert Management Center 9, for all this alert management.

The device 1 optionally also comprises a gyroscope and a digital compass to obtain an estimate of the position in the absence of a satellite signal 4.

The device 1 optionally also comprises short-range radio communication means, i.e. Bluetooth, infrared, or any other form of conventional short-range radio communication for sending the position to other devices 1 having these same means.

Any conventional GNSS system (Global Navigation Satellite System), such as GPS, Galileo, GLONASS, can optionally also be used as a system of satellites 8.

FIG. 2b shows a device for the automotive environment 10 and valid for recovering vehicles according to a preferred embodiment of the present invention. The device for an automotive environment 10 comprises a portable device 1b and an external connecting cable 19. Said external connecting cable 19 allows supplying the device for an automotive environment from the battery of the vehicle, making the use of the internal battery 13 of the device 1b unnecessary. This cable in turn allows connecting the device to the contact of the vehicle and also to other elements, sensors, through analog and digital inputs/outputs and serial port which it has.

The device for an automotive environment 10 has all the functionality existing in the locator device 11b. The device for an automotive environment is further suitable to be installed in vehicles and has two alerts added to those of the device 1: it has the described power supply cutoff or failure alert and the warning alert due to the vehicle trailer. Both devices 1 and 10 differ in physical aspects: The device for an automotive environment 10 of FIG. 2b comprises external connecting cable, which allows the adaptation for the automotive sector, and its locator device 1b comprises a casing with supports for the installation, the casing being strong in order to be inserted into a vehicle.

The device for the automotive environment allows identifying the driver by making use of RFID (Radio Frequency Identification) technology. In this case an RFID receiver-emitter (53) is connected through the serial port for connecting the external cable, as shown in FIG. 2b. The driver of the vehicle has in this case an RFID tag, which allows his or her identification by the system each time the driver enters/exits the vehicle. The device for the automotive environment 10 can communicate the identification of the driver to the server 2 through the data connection 5 on the communication network 3.

The installation of the device for an automotive environment 10 inside a vehicle is simple and can be carried out in any power supply socket of the vehicle allowing it to be easily concealed. The installation of the device for an automotive environment 10 has also been provided in areas of the vehicle with strong GPS attenuations, for which the locator device 1b has an external GPS socket for connecting an external antenna if necessary.

As with the locator device 1 of FIG. 2a, the locator device 1b of the device for an automotive environment 10 comprises the following functional blocks: a A-GPS/GPRS module, preferably four-band; an accelerometer, preferably with three axes; a back-up battery; an internal GPS antenna; an internal GPRS antenna, a microcontroller; optionally, an external GPRS antenna and an external GPS antenna.

In addition, the device for an automotive environment 10 and the locator device 1b comprised therein implement the following interfaces: debugging/programming/configuration lines; 12V/24V power supply (automotive power supply); digital inputs and outputs; analog inputs and outputs; power supply connector, robust casing with anchoring and suitable for automation; GPS antenna connector (the connection of which disconnects the internal antenna); external GPRS antenna connector; two-color green-red LED (“power”); orange LED (GPRS); blue LED (GPS).

The locator device 1b comprises an internal battery which allows it to function as a portable and autonomous device. As has been explained, this internal battery is used when a failure in the power supply from the vehicle is detected, due to a cut of the external cable 19 or power supply failure.

FIG. 2c shows a diagram of the locator device 1b of the device for an automotive environment 10, an external GSM/GPRS antenna connector 52, LEDs 57-1 57-2 57-3, an external GPS antenna connector 51 and a connector 55 for connecting the external cable for supplying, adapting and isolating the signals 19.

The casing of the locator device 1b is formed by a material suitable for the installation in typical automotive adverse conditions. Non-limiting examples of these materials are plastics with high resistance to heat changes, metals. The way of securing the device for an automotive environment 10 (and consequently the locator device 1b) allows fixing it by means of flanges or screws to any part of the vehicle. Non-limiting examples of fixing means are any which allow an easy installation, such as flanges, screws, rivets, belts, pins, etc.

The installation of the device for an automotive environment 10 is recommended in areas such as the engine compartment, below the glove compartment or in a place which cannot be seen in order to be able to be used as a vehicle anti-theft system, always taking into account the placement of the power supply and of the antennas of the locator.

The firmware included in the device is prepared to facilitate the execution of an installation test, by means of which the correct installation of said firmware is verified by the interaction between server 2 and the device for the automotive environment 10.

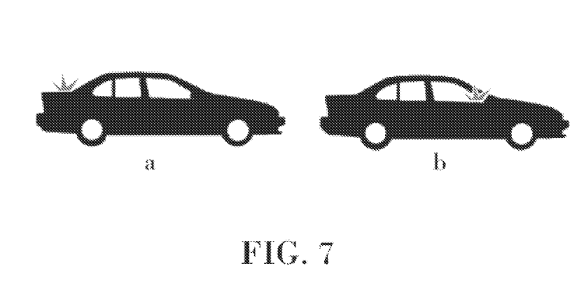

FIGS. 7a and 7b show possible places of the vehicle in which it is recommended to install the external GPS and/or GSM/GPRS antennas. The position of the antennas allows a correct operation of the receivers of the device for an automotive environment 10. Concealing the device for an automotive environment 10 or GPS antenna (optional) below the inner shelves or dashboards of the vehicle is recommended.

FIG. 3 shows a diagram of the server 2 of the system of the present invention. The server 2 comprises a processor 23 controlling the rest of the elements of the server. The server 2 or service platform communicates with the location device 1 through a data channel 5 provided on the wireless communication network 3. On this data channel 5 the server 2 can automatically provide the portable device 1 GPS assistance (A-GPS) information, occasional location requests for the on demand mode (which is explained below), receive information from the device (location, change of state . . . ). The A-GPS assistance information is periodically provided. The server 2 receives information from the location device 1 on the data channel 5, as explained below.

The server 2 also comprises a GPS assistance information sub-system 20, including a database necessary for sending the GPS assistance information and in charge of the management for obtaining, treating and sending said information to the device 1. The information of this sub-system 20 is obtained by means of the connection to a GPS reference network containing information on the spatial/temporal situation of the GPS satellites.

The server 2 also comprises a geographic information sub-system 21 (commonly known as GIS: “Geographic Information System”) comprising a cartographic database including the necessary maps whereby a response will be given from the server 2 of the system to the user 6. This sub-system manages all the actions relating to the cartography request, positioning on the cartography of the location of the device, path, geocoding (conversion of coordinates into street/number and vice versa) . . . .

The server 2 also comprises a user management sub-system 22 including a database with the information associated to such users. Said sub-system 22 is used at least for the management of the registration, cancellation, permissions, privacy, security, spatial temporal preferences of the users. This type of management is always closely related or is necessary in the location services (LBS, Location Based Service).

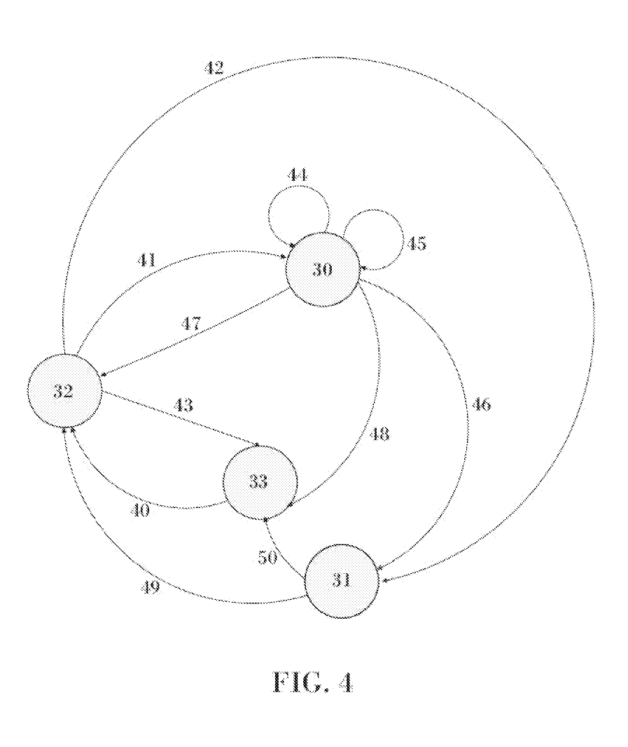

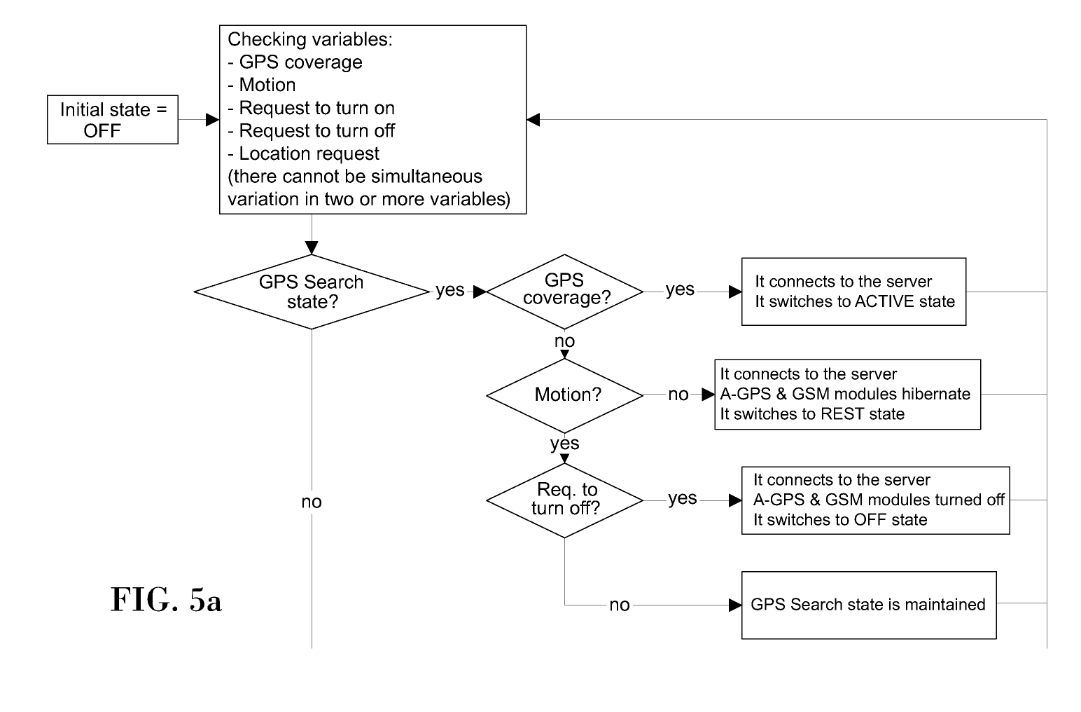

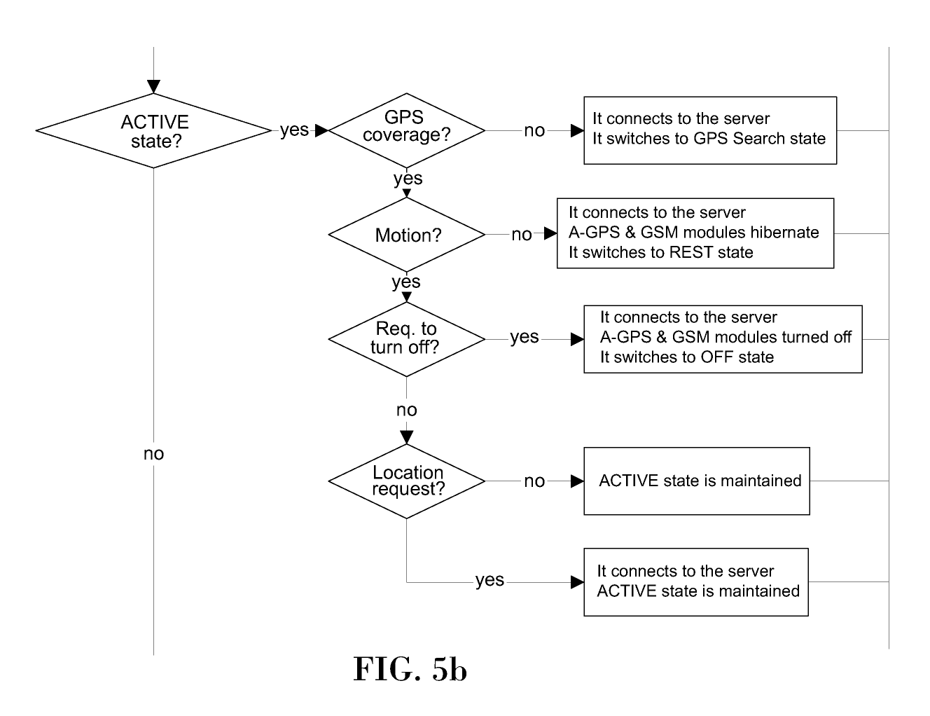

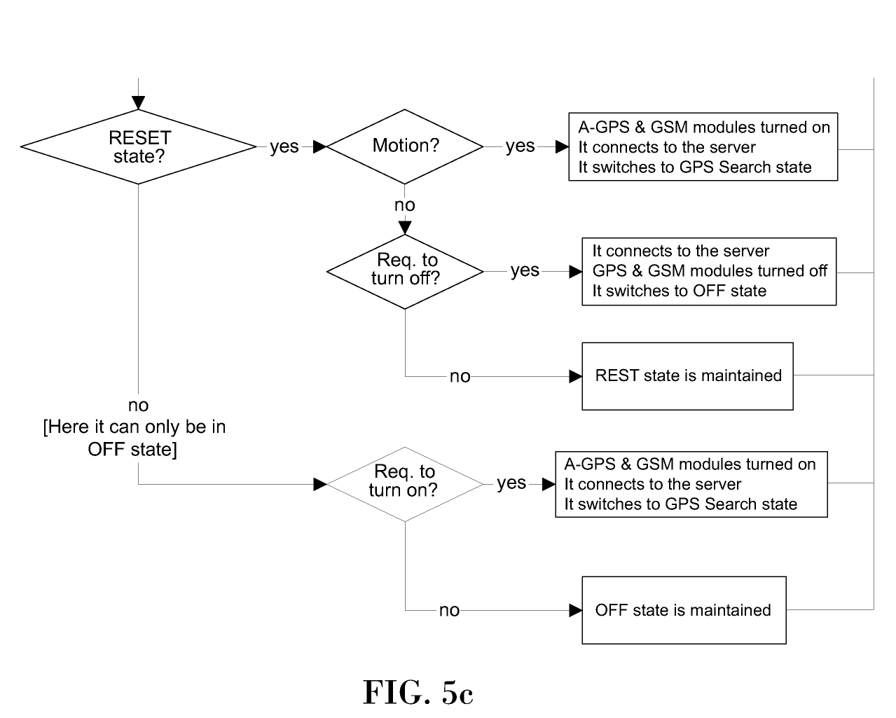

The location method from an operating algorithm of the system of FIG. 1 is detailed below. This operating algorithm is exemplified in the state diagram of FIG. 4. FIG. 5 shows the flow chart of the operating algorithm of the system of FIG. 1. In other words, FIGS. 4 and 5 show two possible alternatives for explaining the operating algorithm.

The location device 1 can be in one of the following states explained below, ACTIVE state 30, REST state 31, GPS SEARCH state 32 and OFF state 33.

The reasons for the transitions between states 30, 31, 32, 33 are the following:

loss/recovery of GPS coverage;

absence/recovery of motion (detected through the information obtained from the motion sensor 14 of the device, which is always available, and from the speed of the device obtained from the A-GPS positioning module 11 thereof, which is only available is it has GPS coverage);

turning on/turning off of the device, either because the battery is used up or due to the use of the encoded key (by means of USB, for example).

The following actions can be carried out by the location device 1:

turning on/turning off/hibernating the A-GPS location module 11;

turning on/turning off/hibernating the transmission/receiving module 12;

connecting to the server 2 to:
Send the last location which is available in the A-GPS positioning module 11 and the time associated to said location (note that the device is continuously calculating its own position provided that it has GPS coverage).
Send the gravity value measured in the motion sensor 14.
Send the locations, if any, stored in the local memory 16 of the device (this occurs when coverage of the wireless network 3 has been lost and the device, by the operating mode it has, continues storing locations locally, or because it has thus been defined according to the process).
Send from the location device 1 to the server 2 a change of state of the device 1, in the event that said transition between states exists.
Check if a request for the device to change the operating mode has existed in the server.

waiting for the recovery of the signal of the mobile communication network 3, in the event that it has been lost.

As mentioned previously, the assistance information (A-GPS) is sent automatically and, preferably, periodically from the server 2 to the location device 1, through the data channel 5 existing between both elements 1, 2, over the wireless communication network 3. Thanks to this assistance information (A-GPS), the location device 1 can carry out locations in a shorter time period than that necessary with systems using (autonomous) conventional GPS systems. This further involves savings in the battery of the location device 1 and a subsequent increase of autonomy over time.

Furthermore, when the location device 1 loses coverage of the wireless communication network 3 but still has GPS coverage, therefore it continues to calculate its locations, the device 1 stores these locations locally (in the memory 16), until recovering the coverage of the wireless communication network 3. When it is recovered, the device 1 can now be connected to the server 2, send it the stored information, if any, check if there is a request to change the operating mode in the server, etc.

Each of the four states shown in FIG. 4 is detailed below:

### OFF State (33)

This OFF state 33 is the state in which the location device 1 is completely turned off, i.e. both the A-GPS positioning module 11 and the transmission/receiving module 12, the microprocessor 15 and the motion sensor 14, are turned off or disconnected (with no energy consumption).

There is only one possible transition in this OFF state 33: the transition occurring when, upon turning on the device 1, it switches to the GPS SEARCH state 32. This transition is shown in FIG. 4 with reference number 40, and the following actions are carried out by the device 1: turning on the A-GPS positioning module 11 and the transmission/receiving module 12, connecting to the server 2 to inform it of the new GPS SEARCH state 32 it is switching to; and waiting until obtaining GPS coverage. Note that during this transition 40, in the event that the device 1 has outdated A-GPS information, the open connection 5 with the server 2 can be used to update it.

### GPS SEARCH State (32)

This GPS SEARCH state 32 is the state in which the device 1 has both the A-GPS positioning module 11 and the transmission/receiving module 12 turned on, but does not have GPS coverage. The transmission/receiving module 12 is preferred to be turned on instead of turned off to not affect the autonomy of the device, due to the fact that the off/on switching and vice versa has a high energy consumption, and we consider that out-of-coverage states can be temporally brief. If, in this state 32, a location request is received from a user 6 (shown in FIG. 1), the server 2 can provide the user 6 with the last location stored which it has of the vehicle carrying the location device 1 and inform him or her that the location device is out of GPS coverage at that time.

There are three possible transitions 41, 42, 43 from this state 32:

1) Transition 41: If GPS coverage is obtained, the device 1 switches to the ACTIVE state 30. The device 1 connects to the server 2 and actions associated to this transition 41 are carried out to check what happened during the period in which it was without GPS coverage and if there has been a switching request for switching the operating mode of the device. The A-GPS positioning module 11 and transmission/receiving module 12, which were turned on, continue to be on.
2) Transition 42: If the device 1 detects, through the motion sensor 14, the absence of motion (i.e. if the device 1 has stopped), the device 1 switches to the REST state 31. Note that the decision for this transition 41 is made only from the information of the motion sensor 14, because since there is no GPS coverage it is impossible to obtain speed data from the A-GPS positioning module 11. Before entering this state 31, the device 1 connects to the server 2 to inform it that its state changes to the REST state, to check if there has been a request to change the operating mode of the device 1 in the server 2, and the A-GPS positioning module 11 and transmission/receiving module 12 further switch to Hibernation.
3) Transition 43: If the device 1 is completely turned off, either because the battery 13 is used up or due to the manipulation of its carrier through the use of the USB key 18, the device 1 switches to the OFF state 33. The actions that are carried out are the following: connecting with the server 2 to inform it about the OFF state 33 it is switching to, checking if there has been a request to change the operating mode of the device 1 in the server 2 and turning off the transmission/receiving module 12 and the A-GPS positioning module 11. If, for example, the device 1 has no battery left, it is interesting for the server 2 to know this in case a user 6 is attempting to locate the vehicle carrying the device 1, in order to be informed of this.

### ACTIVE State (30)

This ACTIVE state 30 is the state in which the device 1 has both the A-GPS positioning module 11 and the transmission/receiving module 12 turned on, and it further has GPS coverage.

In this ACTIVE state 30, the device 1 can be self-located for two reasons: because there is a specific request communicated from the server 2 (transition 45) or because there is a pre-programmed request that is repeated every certain time interval Tx (transition 44).

The first type of self-location, i.e. transition 45, corresponds to an on demand operating mode, which will be explained below.

The second type of self-location, i.e. transition 44, corresponds to a tracking operating mode, which will also be explained below.

After the self-location 44, 45 of the device 1, the latter communicates with the server 2 to send the last location obtained from the A-GPS positioning module 11 and to check if there has been a request to change the operating mode of the device 1 in the server 2.

There are three possible transitions 46, 47, 48 from this state 30 to other states:

1) Transition 46: this transition is shown in FIG. 4 with reference number 46 and occurs from the information obtained from the motion sensor 14 of the device 1, and because a null speed of the device has been obtained from the A-GPS positioning module 1. Once this decision is made, the device then communicates with the server 2 to send the last location available in the A-GPS positioning module 11, to check if there has been a request to change the operating mode of the device 1 in the server 2 and to inform on the REST state it is switching to. It further switches to the Hibernation of the A-GPS positioning module 11, the transmission/receiving module 12 and of the microprocessor 15 itself.
2) Transition 47: If GPS coverage is lost, the device 1 switches to a GPS SEARCH state 32. This transition is shown in FIG. 4 with reference number 47, and the following actions are carried out by the device 1: connecting with the server 2 to inform that it switches to the GPS SEARCH state 32, checking if there has been a request to change the operating mode of the device 1 in the server 2 and sending the last A-GPS location available in the A-GPS positioning module. In the event that there is a location attempt or request for locating the device 1 by a user 6, the server 2 can give the user 6 the last stored location it has (together with the time at which it occurred) and informing that the device 1 is outside of GPS coverage at that time. The A-GPS positioning module 11 and transmission/receiving module 12 are still turned on in said transition 47.
3) Transition 48: If the device 1 is turned off completely, for example due to the battery 13 being used up, the device 1 switches to an OFF state 33. The actions which are carried out are: connecting with the server 2 to inform about the OFF state 33 it is switching to and if the battery is used up, sending the last location available in the A-GPS positioning module 11, checking if there has been a request to change the operating mode of the device 1 in the server 2 and turning off the transmission/receiving module 12 and the A-GPS positioning module 11. If during state 33 the server 2 receives a location request for locating the device 1 from a user 6, the server can return the last location of the device 1 before being turned off, informing that it is in the OFF state and that this is because of the battery being used up or because of a decision made by the carrier of the device.

### REST State (31)

This REST state 31 is the state in which the device 1 has the A-GPS positioning module 11 and the transmission/receiving module 12 and the microprocessor 15 in the Hibernated operating mode (low consumption), but the motion sensor 14 is on and working in normal mode. Since both modules 11, 12 are in the low energy consumption mode, autonomy of the device is prolonged.

The following possible transitions exist in this REST state 31:

1) Transition 49: When the device 1 recovers motion, this transition occurs when such device switches to the GPS SEARCH state 32. The device 1 detects that it is in motion through the motion sensor 14 (it detects the acceleration), this time however it cannot obtained the data of the speed of the device 1 from the A-GPS positioning module 11, because this module is in the low consumption or hibernated operating mode in which it is not processing the GPS signal 4 and therefore does not calculate the speed of the GPS either. This transition is shown in FIG. 4 with reference number 49, and the actions carried out by the device 1 at the time when the motion sensor 14 detects the motion of the device, are the following: turning on the A-GPS positioning module 11 and the transmission/receiving module 12, connecting with the server to inform about switching the state, checking if there has been a request to change the operating mode and waiting until obtaining GPS coverage. It is important to observe that during this transition 49, in the event that the device 1 has outdated A-GPS information, the open connection with the server 2 can be used to update it.

It must be pointed out that in this REST state 31, the system has an optimized operation because if a location request reaches the server 2 from a user 6, the server 2 carries out the following actions depending on:

If its prior state was the ACTIVE state 30: It responds with the current location of the device 1, despite the fact that specific communication with such device has not even been needed and that the device is in REST, in a hibernated mode (low consumption), prolonging the autonomy thereof.

If its prior state was the GPS SEARCH state 32: It responds with the last stored location and with the hour associated thereto, notifying the user 6 that since GPS coverage has been lost, it is possible that this sent location is not the current location (because its prior state was the out of GPS coverage state). The user 6 is further informed that as soon as the device 1 recovers coverage of the GPS network and of the wireless communication network 5, it will be located and updated information will be given to the user 6.

2) Transition 50: If the device 1 is turned off completely, for example due to the battery 13 being used up, the device 1 switches to the OFF state 33. The actions which are carried out are: connecting with the server 2 to inform about the OFF state 33 it is switching to, checking if there has been a request to change the operating mode of the device 1 in the server 2 and turning off the transmission/receiving module 12 and the A-GPS positioning module 11.

In summary:

When the device 1 is in the OFF state 33, the A-GPS positioning module 11, the transmission/receiving module 12, the motion sensor 14 and the microprocessor 15 are turned off.

When the device 1 is in the GPS SEARCH state 32, the A-GPS positioning module 11, the transmission/receiving module 12, the motion sensor 14 and the microprocessor 15 are turned on.

When the device 1 is in the ACTIVE state 30, the A-GPS positioning module 11, the transmission/receiving module 12, the motion sensor 14 and the microprocessor 15 are turned on.

When the device 1 is in the REST state 31, the A-GPS positioning module 11, the transmission/receiving module 12 and the microprocessor 15 are hibernating, whereas the motion sensor 14 is turned on.

The possible states of the device 1 and the transitions it may switch to have been described up to this point. The two possible operating modes of the entire system are described below in relation to the information a user 6 receives regarding the position of the device 1. These two modes are: “on demand” and “tracking”. Said user 6 must obviously be authorized to obtain said information, which can all be verified in the user management sub-system 22. Authorization itself is not the object of the present invention.

For an authorized user 6 to be able to access the information on the location of the device 1, the user 6 must connect with the server 2 through a communication network 7. This network 7 can either be a data network from a personal computer, for example Internet, or a mobile communication network from a mobile terminal or PDA, such as GSM, GPRS. The user 6 can also receive (for example, in his or her mobile telephone or PDA), a map with the information of the location of the device 1. The user can also contact a service provider help center by making a telephone call.

The user 6 can further carry out the entire configuration of the device 1, including the management of alerts (definition, activation/deactivation), through the same possible accesses to the server 2.

### On Demand Mode

This mode, also referred to as request-response mode, is the basic operating mode of the system. The user 6, who is the end customer, requests the location of a device 1 by means of any possible type of access which allows connecting with the network 7, such as a computer with access to Internet (web page), mobile telephone, PDA. The server 2 then responds, if possible, with the sending of a map showing the current location of the device 1, or with a corresponding message in the event that the location information of the device 1 could not be provided at that time.

In this on demand mode, there is no established time for the device 1 to carry out self-locations (transitions 44 and 45 of FIG. 4). Therefore, the device 1 does not periodically carry out self-locations. The server 2 responds to occasional location requests by the user 6.

### Tracking Mode

This mode is used to continuously track the device 1. In other words, the system is continuously monitoring the device 1, and therefore, the person or vehicle (in the case of a device for the automotive environment 10) which has such device associated thereto or installed therein.

In this mode, the device 1 is self-located every certain time period “Tx” that can be configured in the server 2 and sends its location to the server 2. This mode further allows any occasional request from the server 2, i.e. it includes the possibilities offered by the on demand mode. If the device 1 loses coverage of the communication network 3, such that it is not possible to send the location to the server 2, the device continues self-locating itself every period “Tx” defined above and storing in its local memory 16, so that later when it recovers coverage of the mobile network, it can communicate with the server 2 and send locally stored the locations. At this time it sends to the server all the locations stored in the memory 16 of the device 1.

The user 6 can switch between both modes, as needed. The server 2 informs the device 1 when the state is switched from on demand to tracking, or vice versa.

In this tracking mode, instead of sending the position every time a self-location is performed (i.e. every period “Tx”, the positions can be stored locally in the internal memory 16 of each interval “Tx”, but the communication channel 5 only opens every one greater time interval “Ty” (Ty>Tx)), a group of them can optionally be sent later simultaneously and in a compressed manner so as to reduce the battery consumption of the device 1 and thus increase its autonomy.

The device for an automotive environment 10 comprises, in addition to the already defined functionalities, other typical functionalities, such as activating and configuring digital input/outputs for the device for the automotive environment 10 and more specifically the digital input/outputs of the external power supply cable 19 from the server 2. It is also typical that this device for an automotive environment 10 manages and generates the power supply cutoff/failure and vehicle trailer warning alerts, by the user 6 through the same accesses as the rest of the alerts.

The user 6 can therefore locate one or more devices 1 belonging to several persons and/or installed in different vehicles from the server 2 in real time, and carry out a tracking in real time and generate reports or simply carry out occasional requests of the devices.

The user 6 can also have identified the driver of the vehicle having the device for the automotive environment 10 in real time.

In addition, the device 1 of the present invention allows the user 6 to configure/activate/deactivate a series of alerts through different accesses, such as from a personal computer, from a portable device, through a telephone call and others for example. Each time an alert is configured, the server 2 informs the device 1 of this through the data connection 5 existing on the communication network 3, except for the motion/anti-theft and vehicle trailer warning alerts.

All these are generated in the actual device 1 (more specifically in the locator device 1b), except the motion/anti-theft and vehicle trailer warning alerts, which are generated directly in the server 2.

When an alert is generated in the device 1, the latter communicates it to the server 2 through the data connection 5 existing on the communication network 3.

In all the possible alert cases explained below, once the alert is generated, either from the device itself or from the server 2, the system (either directly from the server 2 or from the Alert Management Center 9) allows informing the user of the event in different ways, by means of a text message to his or her mobile telephone, by means of an e-mail to his or her e-mail address, by means of a call.

It must be noted that the generation and management of the alerts are independent of the operating mode of the device 1 or device for an automotive environment 10.

### 1) Area Alerts

It allows configuring geographical areas and knowing the output, input or input/output of the device 1 in said area in real time. The number of possible simultaneous active alerts can be configured.

In the case of generating an area alert from the device 1, the latter informs the server 2 of this. The server 2 sends an automatic warning with the information of the alert to the external Alert Management Center 9, if the user has configured it in this way.

### 2) Exceeded Speed Alert

This alert allows the user to configure a maximum speed for his or her device 1. The alert is generated in the event that this alert is active and the device exceeds the maximum configured speed.

The GPS speed is among the data which the GPS module 11 of the device 1 has, which is used for generating the alert by comparing it with the maximum speed configured by the user 6.

### 3) Power Supply Cutoff/Failure Alert

As has been mentioned, this alert is typical of the device for an automotive environment 10, due to the fact that it is installed in a vehicle and connected to its battery through the external connecting cable 19. The power supply source of the device is by default the battery of the automobile. In the event that there is any cutoff/failure in this power supply, the device for an automotive environment 10 automatically generates the power supply cutoff/failure alert and proceeds to make use of the internal battery of the device.

As soon as the device for an automotive environment 10 detects the possibility of being supplied from the battery of the vehicle again, said device switches to this power supply source.

4) Low Battery Alert

This alert allows the user to configure a lower battery level threshold.

In the event that the device goes below this threshold, it will generate this alert.

5) Motion/Anti-Theft Alert

This alert is generated directly from the server 2 without the intervention of the device 1.

The functionality of this alert provides the service with the ability to detect the motion of the device 1. In the case of being applied on a device of the automotive environment, it is more suitable to call it an anti-theft alert, since it would allow notifying the owner of a vehicle in the case of a possible theft of the vehicle.

The alert is generated as follows: The alert being active, the server 2 generates the alert when, the device 1 or device for an automotive environment 10 being in the REST state (31), it detects motion through the motion sensor 14 and switches to the GPS SEARCH state (32).

### 6) Vehicle Trailer Warning Alert

This alert is generated directly from the server 2 without the intervention of the device 1.

As has been mentioned this alert is typical of the device for an automotive environment 10. The alert being active, if the server 2 detects from its motion sensor 14 a variation in the inclination of the device greater than the value defined by the user 6, the alert is generated informing the user 6 of this.

The generation of any of the described alerts can be reflected visually and/or with sounds in the Services Web, alerts area and in the corresponding assistance centers and the external support Alert Management Center (AMC), if it exists.

Once an alert is generated it can be reset by the user through the same three ways in which it can activate/deactivate the alert and from the external AMC and/or service centers when they have detected the alert and pass on to its management.

The defined system, specifically for the device for an automotive environment 10, can optionally also support an alert due to theft of the load trailer, which allows notifying the user of a possible theft of the load in those tractor vehicles consisting of two parts: tractor head and load trailer. The system detects, in this case, the separation between both parts and notifies the use of this.

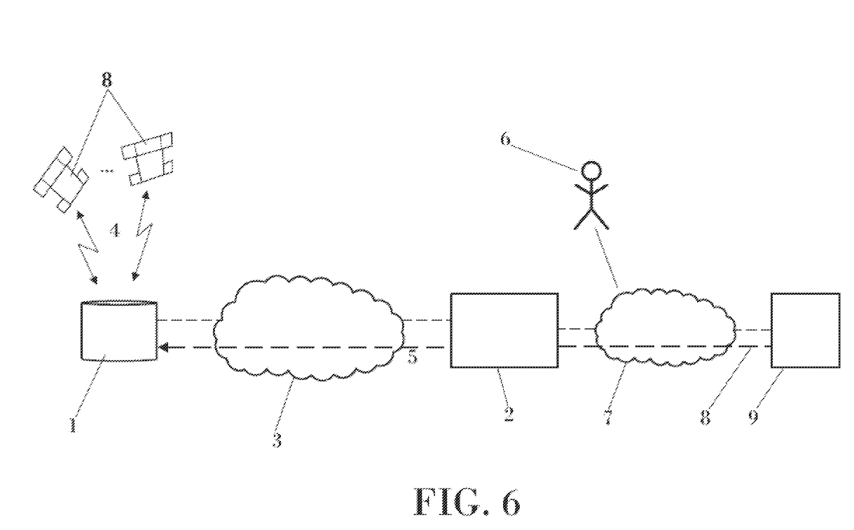

FIG. 6 shows an alternative architecture to that of FIG. 1. This architecture comprises, in addition to the elements of FIG. 1, an external node called Alert Management Center (AMC) 9 connected to the platform of the service, which aids in managing the service for communicating the alerts from the platform.

The location service provided by the invention can be used in both personal environments (installation in his or her individual vehicle) and professional environments (transport companies, taxis, ambulances).

The service also allows accessing the routes made by the vehicle incorporating the device for an automotive environment 10, after defining a range of dates. It also allows generating reports of positions, generated alerts, distances traveled. The service can be accessed through a personal computer or mobile terminal (telephone, PDA) with Internet access.

In view of this description and the set of drawings, a person skilled in the art can understand that the invention has been described according to some preferred embodiments thereof, but that multiple variations (in the system of satellites, the positioning module, wireless communication networks, etc.) can be introduced in said preferred embodiments, without departing from the object of the invention as it has been claimed.

1. A location method for locating a portable device from a server configured to communicate with said portable device through a wireless communication network, in which the method comprises:
sending GPS assistance information from the server to the portable device through said wireless communication network;
obtaining in an A-GPS positioning module of the portable devices a GPS signal from a satellite system;
calculating in said portable device a location of the device itself from said GPS signal and from the GPS assistance information sent by the server;
sending said location to the server;
when the portable device is stopped, hibernating the A-GPS positioning module, a transmission/receiving module and a microprocessor of said portable device manage said modules, such that a battery of the portable device is saved and the autonomy of the portable device is thus increased; and
when the portable device is connected by means of an external cable to a vehicle, said portable device and said external cable form a locator device for an automotive environment, which is supplied from a battery of said vehicle.

2. The method according to claim 1, wherein said hibernating of said modules and said microprocessor is carried out by the portable device according to information obtained from a motion sensor means which can detect motion of said device.

3. The method according to claim 1, wherein the portable device calculates, from information comprised in said GPS signal, a speed of the device, information relating to the speed of the device being used to make the decision to hibernate said modules and said microprocessor.

4. The method according to claim 1, wherein, before said hibernating said modules and said microprocessors, the device sends the server:
a last location obtained by the A-GPS positioning module,
previous locations stored in the device, if any;
and informs the server that the device is going to hibernate said modules and said microprocessor.

5. The method according to claim 1, wherein said calculation of the location of said device is carried out in an on demand mode as a response to specific request from a user, wherein said specific request is carried out through said server.

6. The method according to claim 1, wherein said calculation and sending of the location of said device is carried out in a tracking mode wherein said calculation and said sending are periodically repeated, provided that there is GPS coverage, every certain time period, upon request of a user who determines said time period, through said server.

7. The method according to claim 6, wherein, if the device loses coverage of the wireless communication network, the device stores in a local memory all the locations calculated according to said tracking mode which have not been sent to the server due to a lack of coverage of the wireless communication network, and said locations are sent to the server when the device recovers said coverage.

8. The method according to claim 5, further comprising changing a mode for obtaining locations of the device from the on demand mode comprising specific requests made by said user, to a tracking mode comprising periodical requests every certain time period, upon request of said user, who determines said time period, through said server.

9. The method according to claim 6, further comprising changing the mode for obtaining locations of the device from the tracking mode comprising periodic requests made every certain time period, to an on demand mode comprising specific requests made as a response to a specific request from said user, which request is made through said server.

10. The method according to claim 9, wherein every time the device connects with the server through said wireless communication networks, the device checks if in said server there is a request demanded by a user for changing from the tracking mode to the on demand mode, or vice versa, and if that is the case, the device performs said change.

11. The method according to claim 1, wherein, if GPS coverage is lost by the A-GPS positioning module, the A-GPS positioning module and the transmission/receiving module being turned on, the portable device sends the server:
the last location obtained by the A-GPS positioning module, and
previous locations stored in the device, if any;
and informs the server that GPS coverage has been lost.

12. The method according to claim 1, wherein, if the device begins to move after having been stopped and with the A-GPS positioning module and transmission/receiving module hibernated, the following steps occur:
turning on the A-GPS positioning module,
turning on the transmission/receiving module,
informing the server that said modules have been turned on and that said modules are trying to obtain GPS coverage.

13. The method according to claim 1, wherein the portable device can be turned off voluntarily by means of an encoded key that a carrier of the device has, or automatically due to the battery of the portable device being used up.

14. The method according to claim 13, herein the portable device, before being turned off:
informs the server that the device is going to be turned off,
sends the server the last location obtained by the A-GPS positioning module and
sends the server previous locations stored in the device, if any.

15. The method according to claim 1, wherein, when the portable device is turned on by a carrier, the following steps occur:
both the A-GPS positioning module and the transmission/receiving module are activated,
the device begins to search for GPS coverage, and
the device informs the server of this.

16. The method according to claim 15, wherein, when the portable device obtains GPS coverage and has the A-GPS module and the transmission/receiving module turned on:
the device informs the server of this and
the device sends its current location.

17. The method according to claim 6, wherein, if the portable device loses coverage of the wireless communication network and is in motion, the device:
continues calculating its locations from said GPS signal and from GPS assistance information sent, and
stores said locations in a memory of the device to be sent to the servers when the device has recovered said coverage of the wireless communication network.

18. The method according to claim 1, wherein, each time the device sends the server any of the locations obtained in the A-GPS positioning module, it also includes a time associated to each of said locations.

19. The method according to claim 1, wherein the server is configured to inform a user of a position of the portable device, and wherein the server sends said user the last position obtained by the portable device.

20. (canceled)

21. The method according to claim 19, wherein, if the device is stopped, the server sends the user the last position of the device that the server has stored, wherein said last position has been sent from the device to the server before hibernating the A-GPS positioning module and transmission/receiving module.

22. The method according to claim 21, wherein, if before the device stops, the device has both GPS coverage and coverage of the wireless communication networks, the device informs the user that the information of the position sent corresponds to the current position of the device.

23. The method according to claim 21, wherein, if before the device stops, the device does not have GPS coverage, the device informs the user that the information of the position sent may not correspond to the current position of the device, in which case said information corresponds to the last position that the device was able to calculate before losing GPS coverage.

24. The method according to claim 19, wherein, if the device is in motion but has lost GPS coverage, the server sends the user the last position of the device that the server has stored, wherein said last position has been sent from the device to the server before losing GPS coverage, and the server informs the user that:
the information of the position sent may not correspond to the current position of the device, but rather that the information corresponds to the last position that the device was able to calculate before losing GPS coverage and
the device is searching for GPS coverage.

25. The method according to claim 19, wherein, if the device is turned off, the server sends the users the last position of the device that the server has stored, and the server informs the user that:
the information of the position sent may not correspond to the current position of the device,
the device is turned off.

26. The method according to claim 19, wherein said user receives the position of the portable device from the server as a response to an occasional request initiated by the user.

27. The method according to claim 19, wherein said user periodically receives the position of the portable device from the server every certain time which can be configured in the system and according to a prior agreement established for the automatic sending of locations.

28. The method according to claim 19, wherein the user receives the position of the portable device in a manner comprising: shown on a cartographic map which can be accessed from a fixed terminal or a mobile terminal, shown in text formats or by means of an audio file.

29. The method according to claim 1, which further comprises sending a user at least one alert related to a state of the portable device or of a device of an automotive environment.

30. (canceled)

31. (canceled)

32. The method according to claim 29, wherein said alert is an area alert which allows configuring at least one geographical area and knowing the output and input of the device in said area in real time.

33. The method according to claim 29, wherein said alert is a speed alert which is generated if the device exceeds a previously configured speed threshold.

34. The method according to claim 29, wherein said alert is a battery alert which is generated if the battery level of the device passes from being above a previously configured threshold to being below said threshold.

35. The method according to claim 29, wherein said alert is a power supply cutoff alert which is applied to the device for an automotive environment and which is generated if a power supply of the device provided by the battery of the vehicle to which said device is connected is interrupted.

36. The method according to claim 29, wherein said alert is a vehicle trailer warning alert which is applied to the device for an automotive environment and which is generated from the server if an inclination of the vehicle, detected by a motion sensor mean, exceeds a previously established threshold.

37. The method according to claim 29, comprising the step of configuring the service and managing said alerts by the user by means of web access from a computer, from a mobile terminal, or by means of telephone access.

38. The method according to claim 37, comprising the step of sending said alert from said server to a user by means of sending an SMS to a mobile telephone of the user, by means of sending an e-mail to the user's e-mail address, or by means of a voice call to the user's mobile or fixed telephone.

39. The method according to claim 1, further comprising the step of identifying a driver of the vehicle incorporating a device for an automotive environment through an RFID tag carried by said driver, said RFID tag being detected by an RFID receiver-emitter connected to the device.

40. The method according to claim 1, further comprising the step of sending a measured gravity value from said devices to said server.

41. A portable device comprising:
A-GPS global positioning means configured to receive a GPS signal from a network of GPS satellites;
transmission/receiving means configured to connect with a wireless communication network and to receive therethrough, from a server, at least GPS assistance information and location requests;
wherein said portable device can calculate its position from said GPS assistance information and from said GPS signal and can send said position to said server;
wherein,
the portable device comprises motion sensor means which can capture information that can be used for hibernating or interrupting the hibernation of said A-GPS positioning module and transmission/receiving module, according to the absence or presence of motion of the portable device, and which can capture a measurement of the gravity.

42. The device according to claim 41, wherein said motion sensor means comprise an accelerometer.

43. The devices according to claim 41, also comprising a microprocessor which can control said A-GPS positioning means, said transmission/receiving means, said motion sensor means and an internal storage memory belonging to the device.

44. (canceled)

45. (canceled)

46. (canceled)

47. The device according to claim 41, further comprising visual means for indicating the state of a battery, of said A-GPS positioning means and of said transmission/receiving means.

48. A device for an automotive environment comprising a portable device according to claim 41, and an external cable configured to be connected to a vehicle carrying said device for an automotive environment, said device for an automotive environment being configured to be supplied power through an internal battery of the portable device in the event that a failure in said external cable occurs and to be supplied through a battery of the vehicle to which it is connected by means of said external cable in the rest of the cases and wherein said external cable further comprises a plurality of analog and/or digital inputs and/or outputs and at least one serial port adapted to be connected to other sensors devices and/or points of the vehicle to be monitored.

49. (canceled)

50. (canceled)

51. A location system for a portable device comprising:
at least one portable device according to claim 41; and
a server, configured to communicate through a data channel with said portable device through a wireless communication network and to automatically provide GPS assistance information to said portable device.

52. (canceled)

53. The system according to claim 51, wherein said server comprises a GPS assistance information sub-system, in turn comprising a database which can store the assistance information, in charge of the management for obtaining, treatment and sending the GPS assistance information from the server to the device.

54. The system according to claim 51, wherein said server further comprises a geographic information sub-system, in turn comprising a cartographic database which can store maps, wherein said geographic information sub-system is configured to manage actions related to cartography requests, positioning on said cartography of the location of the device, geocoding, and reverse geocoding.

55. The system according to claim 51, wherein said server further comprises a user management sub-systems, in turn comprising a database which can store information associated to users, wherein said user management sub-system is configured to manage registration, cancellation, permissions, privacy, security and spatial temporal preferences of the users.

56. The system according to claim 51, further comprising an external node connected to the server through a data network for aiding in the management of an alert communication service from the server.

57. (canceled)
